(19) United States
(12) Patent Application Publication
(10) Pub. No.: US 2007/0080512 A1
(43) Pub. Date: Apr. 12, 2007

(54) Storage systems and methods for equipment

(76) Inventors: Brett Bartholmey, Bellingham, WA (US); William E. Bruders, Sedro Woolley, WA (US)

Correspondence Address: SCHACHT LAW OFFICE, INC., SUITE 202, 2801 MERIDIAN STREET, BELLINGHAM, WA, 98225-2412, US

(21) Appl. No.: 11/540,210

(22) Filed: Sep. 27, 2006

Related U.S. Application Data
(60) Provisional application No. 60/721,846, filed on Sep. 28, 2005.

(51) Int. Cl. B62B 1/00

(52) U.S. Cl. 280/47.24

(57) ABSTRACT

A hand cart for a first item having a lift bar, comprising a frame assembly, a wheel assembly, a carriage assembly, and a hook. The wheel assembly is rigidly connected to the frame assembly to facilitate movement of the hand cart along a surface. The carriage assembly is connected to the frame assembly for movement along an engaging axis relative to the frame assembly. The hook extends from the carriage assembly. With the frame assembly adjacent to the first item, the carriage assembly is displaced such that the hook engages the lift bar of the first item. With the hook engaging the lift bar, the frame assembly is tilted such that the wheel assembly supports the first item for transport.

### RELATED APPLICATIONS

This application claims priority of U.S. Provisional Patent Application Ser. No. 60/721,846 filed Sep. 28, 2005, the contents of which are incorporated herein by reference.

### TECHNICAL FIELD

The present invention relates to the storage and transportation of portable equipment and, more particularly, to the transportation and storage of equipment of various form factors in a motor vehicle and then transportation of this equipment from the motor vehicle to a job site.

### BACKGROUND OF THE INVENTION

Industries such as the construction and restorative drying industries utilize a variety of types of equipment of different sizes, shapes, and weights. This equipment is typically stored in and/or transported by a truck to the building where the equipment is to be used.

The need exists for hand trucks and storage systems for equipment that optimizes the use of storage and transportation space and which allows the equipment to be efficiently moved from a truck to the building where the equipment is to be used.

### SUMMARY OF THE INVENTION

The present invention may be embodied as a hand cart for a first item having a lift bar, comprising a frame assembly, a wheel assembly, a carriage assembly, and a hook. The wheel assembly is rigidly connected to the frame assembly to facilitate movement of the hand cart along a surface. The carriage assembly is connected to the frame assembly for movement along an engaging axis relative to the frame assembly. The hook extends from the carriage assembly. With the frame assembly adjacent to the first item, the carriage assembly is displaced such that the hook engages the lift bar of the first item. With the hook engaging the lift bar, the frame assembly is tilted such that the wheel assembly supports the first item for transport.

The present invention may further be embodied as part of a larger storage system incorporating a hand cart as described above. In addition, the present invention may be embodied as a method of transporting a first item using a frame assembly, wheel assembly connected to the frame assembly, carriage assembly supported by the frame assembly, and a hook supported by the carriage assembly.

### BRIEF DESCRIPTION OF THE DRAWINGS

FIG. 1 is a front perspective view of a hand cart that may be used as part of the present invention;

FIG. 2 is a rear perspective view of the hand cart of FIG. 1;

FIG. 3 is a front elevation view of the hand cart of FIG. 1;

FIG. 4 is a rear elevation view of the hand cart of FIG. 1;

FIG. 5 is a top plan, partial cut-away view of the hand cart of FIG. 1;

FIG. 6 is a side elevation view depicting the hand cart of FIG. 1 carrying equipment of first and second form factors;

FIG. 7 is a side elevation view of the equipment of the first form factor;

FIG. 8 is a side elevation view of the equipment of the second form factor;

FIG. 9 is a top plan of the hand cart as shown in FIG. 6;

FIG. 10 is a rear elevation view of the hand cart as shown in FIG. 6;

FIG. 11 is a top plan view of equipment of a third form factor;

FIG. 12 is a side elevation view depicting the hand cart of FIG. 1 carrying equipment of the third form factor;

FIGS. 13-16 are side elevation section views illustrating the operation of the hand cart of FIG. 1 when carrying equipment of the third form factor;

FIGS. 17 and 18 are end and side elevation views., respectively, of equipment of the fourth form factor;

FIG. 19 is a side elevation section view illustrating the operation of the hand cart of FIG. 1 when carrying equipment of the fourth form factor;

FIG. 20 is a rear elevation partial cutaway view of the hand cart as depicted in FIG. 19;

FIG. 21 is a side elevation section view illustrating the operation of the hand cart of FIG. 1 when carrying equipment of the fourth form factor;

FIG. 22 is a rear elevation partial cutaway view of the hand cart as depicted in FIG. 21;

FIG. 23 is a side elevation view illustrating the operation of the hand cart of FIG. when carrying equipment of a fifth form factor;

FIG. 24 is an end elevation view of hand cart as shown in FIG. 1 used in conjunction with mounting panels to store equipment on a motor vehicle;

FIG. 25 is a perspective view of another example hand cart of the present invention;

FIG. 26 is a side elevation view of the hand cart depicted in FIG. 25;

FIG. 27 is a side elevation cutaway view of the hand car depicted in FIG. 25;

FIG. 28 is a side elevation cutaway view illustrating the use of the hand cart of FIG. 25 to engage three blowing systems having a first form factor;

FIG. 29 is a side elevation cutaway view illustrating the use of the hand cart of FIG. 25 to engage a plurality of blower systems having a second form factor;

FIGS. 30 and 31 are side elevation cutaway views illustrating the use of the hand cart of FIG. 25 to engage and transport a blower system having a third form factor; and

FIG. 32 is a side elevation cutaway view illustrating the use of the hand cart of FIG. 25 to engage a dehumidifier system having a fourth form factor.

### DETAILED DESCRIPTION OF THE INVENTION

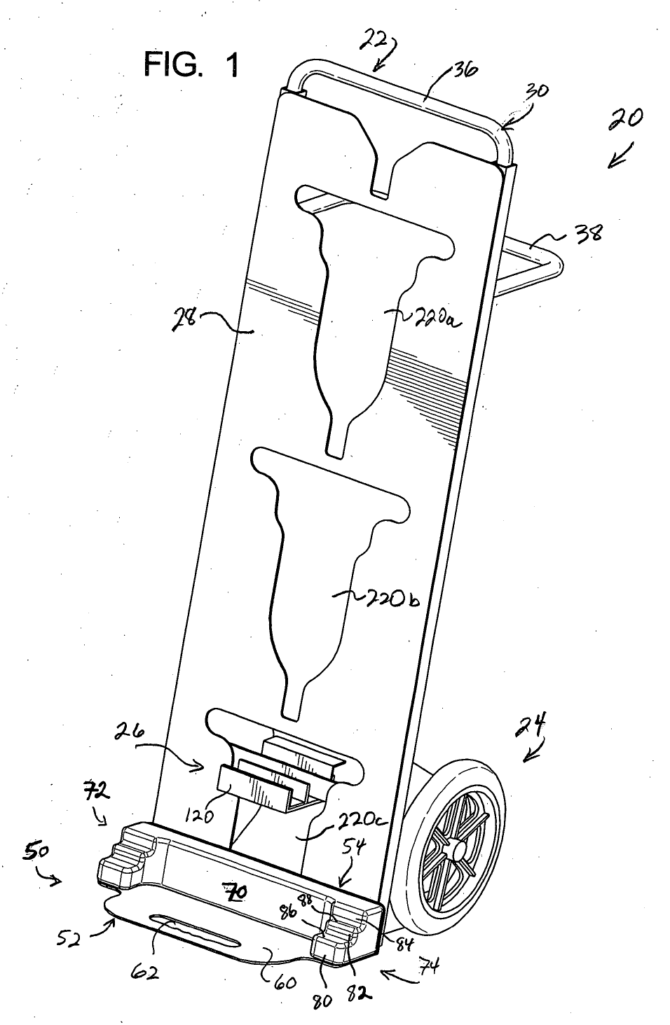

Referring initially to FIG. 1 of the drawing, depicted at 20 therein is a hand cart that may embody, or may be used as part of, a storage system of the present invention.

The hand cart 20 is used to store and/or transport equipment. The term “equipment” as used herein refers to any type of portable device that is too heavy or bulky to be carried easily by hand. Such equipment typically includes a housing and may be provided with a handle, wheels, or the like to facilitate movement. Features of the equipment such as a housing, handle, wheels, or the like define what will be referred to herein as the “form factor” of the equipment. The form factor of a given type of equipment thus generally refers to the three-dimensional shape of that type of equipment.

While the form factor of a given type of equipment stored or transported by the hand cart 20 may not be known in advance, in many situations the hand cart 20 may accommodate several types of equipment having known form factors. In addition, the equipment itself may be designed to facilitate storage and/or transportation by the hand cart 20. The hand cart 20 is thus typically designed for use as part of a larger storage/transportation system, as will be described in further detail below.

The example hand cart 20 comprises a frame 22, wheels 24, an engaging system 26, and one or more mounting panels 28. The wheels 24 are rotatably mounted on the frame 22 to allow the hand cart 20 to be rolled along a structural surface A defined by a vehicle, a ramp, the ground, and/or a dwelling structure. The engaging system 26 is supported at a lower end of the frame 22 to engage equipment to be transported as will be shown and described later. The mounting panels 28 are supported by the frame 22 above the engaging system 26 to allow equipment to be carried by the hand cart 20.

In use, equipment is supported by the frame 22 directly, by the engaging system 26 and the frame 22, and/or by the mounting panels 28. By tilting the hand cart in a conventional manner, the weight of all equipment supported thereby is carried by the wheels 24 such that the equipment may easily be displaced by hand along the structural surface A. In addition, additional mounting panels similar to or the same as the example panels 28 may be secured to a storage surface such as an interior wall of a vehicle to allow equipment to be stored within the vehicle.

The engaging system 26 operates in a latched configuration and in an unlatched configuration. The engaging system 26 may engage certain form factors of equipment carried by the hand cart 20 when in the unclosed position. In the closed position, the engaging system 26 typically does not engage equipment of most form factors.

With the foregoing general understanding of the construction and operation of the present invention, the details of the example hand cart 20 and a typical storage/transportation system will now be described. The example hand cart 20 is optimized for use in the storage and/or transportation of restorative drying equipment. Restorative drying equipment typically takes the form of equipment such as air movers or blowers, dehumidifiers, air filters, wet vacuum systems, ozone generators, heaters, and the like.

The function of a particular piece of restorative drying equipment will strongly influence the form factor thereof, and restorative drying equipment thus exhibits many different form factors. In the following discussion, restorative drying equipment of several different form factors will be described. However, the restorative drying equipment is described as examples of types of equipment that may be stored and/or transported by the example hand cart 20, and the restorative drying equipment described herein is not per se part of the present invention.

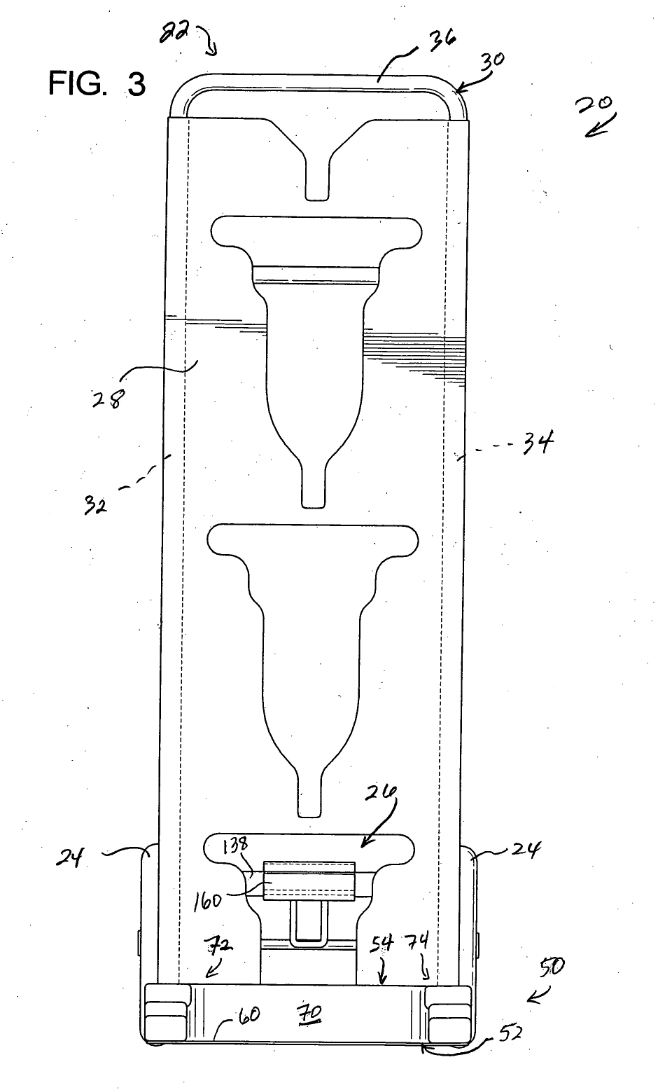

The frame 22 of the example hand cart 20 is a rigid member or assembly that provides sufficient structural integrity for the hand cart 20 to perform the functions described below. As perhaps best shown in FIGS. 1 and 3, the example frame 22 comprises frame member 30 in the form of an inverted U. The frame member 30 defines left and right side support portions 32 and 34 and a handle portion 36. Extending rearward from the frame member 30 is a stand member 38 (FIG. 1).

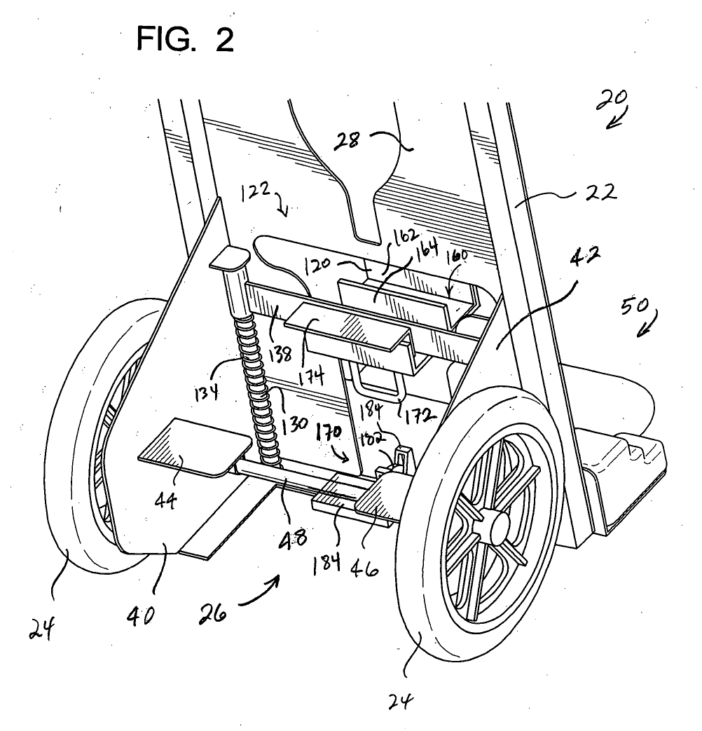

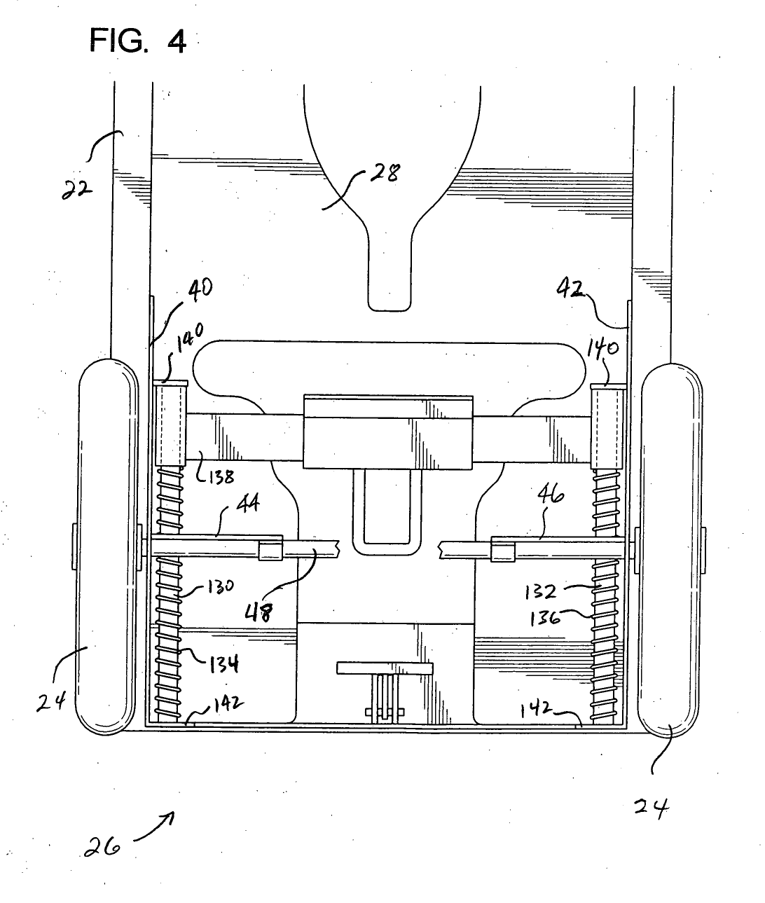

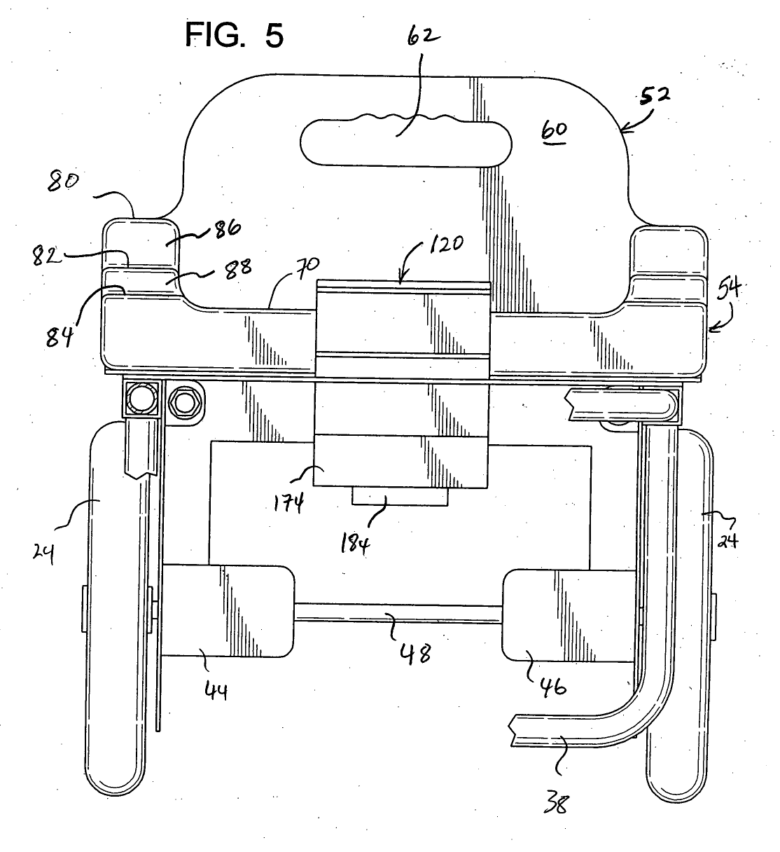

FIGS. 2 and 4 illustrate that the frame 22 further comprises a pair of wheel stand-offs 40 and 42. As perhaps best shown in FIGS. 2 and 4, the wheel stand-offs 40 and 42 extend from the left and right vertical support portions 32 and 34. Extending inwardly from the wheel stand-offs 40 and 42 are axle plates 44 and 46 that support an axle 48 on which the wheels 24 are mounted. The connection of the wheels 24 to the frame is or may be conventional, and other structures may be used for this purpose.

The frame 22 further comprises a platform assembly 50 as perhaps best shown in FIGS. 1 and 3. The example platform assembly 50 comprises a support plate 52 and a bumper member 54. The support plate 52 defines a support surface 60 on which items may be placed while being stored or transported by the hand cart 20. An opening 62 is formed in the support plate 52 to facilitate carrying of the hand cart 20.

The bumper member 54 comprises a central portion 70 and first and second side portions 72 and 74. The central portion 70 is set back slightly from the side portions 72 and 74. The example side portions 72 and 74 are identical, and each of these side portions defines first, second, and third forward surfaces 80, 82, and 84 and first and second upper surfaces 86 and 88. The purpose of the forward surfaces 80, 82, and 84 of the bumper member 54 will become apparent from the following discussion.

The example engaging system 26 will now be described in further detail with reference to FIGS. 1, 2, and 4 of the drawing. The engaging system 26 comprises a hook projection 120, a suspension assembly 122, and a latch system 124. The suspension assembly 122 comprises first and second rod members 130 and 132, first and second springs 134 and 136, and a bridge member 138 extending between the rod members 130 and 132. Upper and lower mounting plates 140 and 142 extend from each of the wheel stand-offs 40 and 42 to support the rod members 130 and 132 in a substantially parallel, spaced-apart arrangement. The example springs 134 and 136 are helical compression springs through which the rod members 130 and 132 extend, respectively, but other biasing configurations may be employed.

The bridge member 138 comprises guide portions 150 and 152 that engage the rod members 130 and 132 such that the bridge member 138 is guided along a guide path that is substantially parallel to the left and right side portions 32 and 34 of the frame 22. Further, the bridge member 138 is supported by the springs 134 and 136 such that these springs bias the bridge member 138 away from the support plate 52.

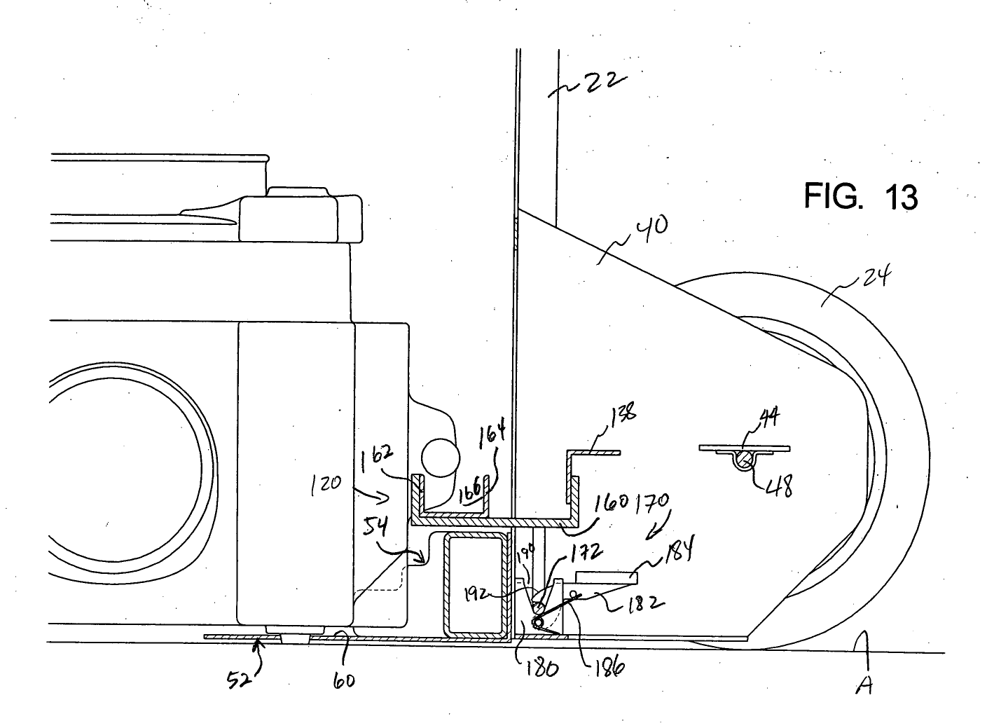

The hook projection 120 extends from the bridge member 138 to a position above the bumper member 54. The example hook projection 120 comprises a lower plate 160 and first and second channel plates 162 and 164 that define a hook channel 166. In the example hand cart 20, the lower plate 160 is welded, bolted, or otherwise connected to the bridge member 138. The hook projection 120 thus moves with the bridge member 138 along the guide path between a first position (FIGS. 1 and 2) and a second position (FIG. 13).

The latch system 124 will now be described in further detail. The latch system 124 comprises a latch assembly 170, a latch bar 172, and a press plate 174. The latch bar 172 and press plate 174 are rigidly connected to the bridge member 138. The press plate 170 is arranged so that a user of the hand cart 20 standing behind the hand cart 20 can force the bridge member 138 to move against the force of the springs 134 and 136. The example latch bar 172 is a U-shaped member that extends from the bridge member 138 generally towards the latch assembly 170.

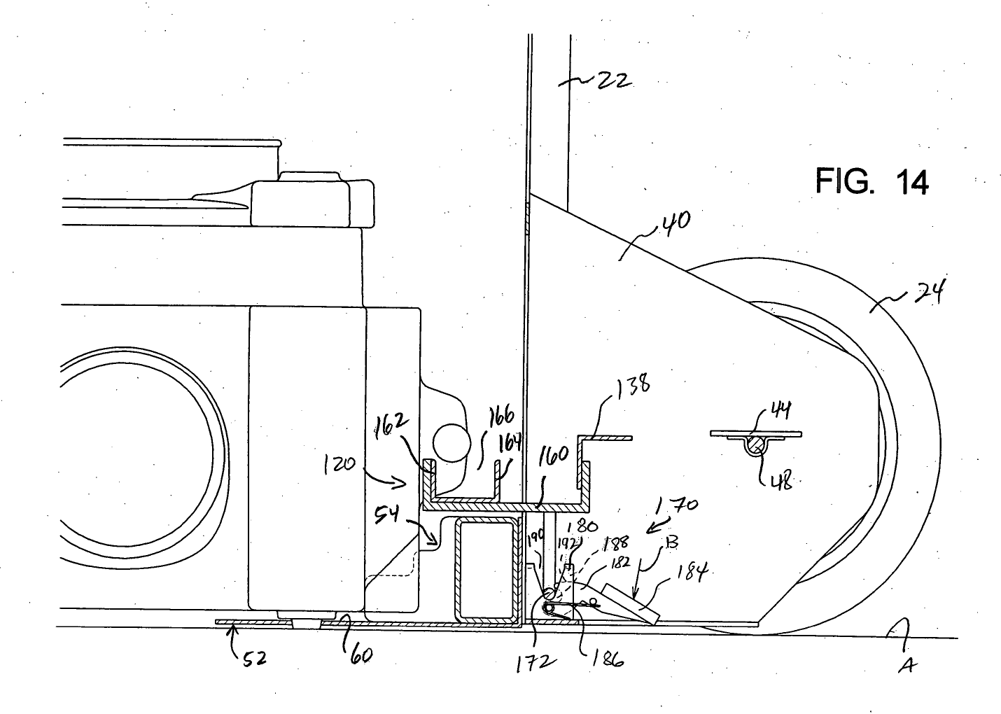

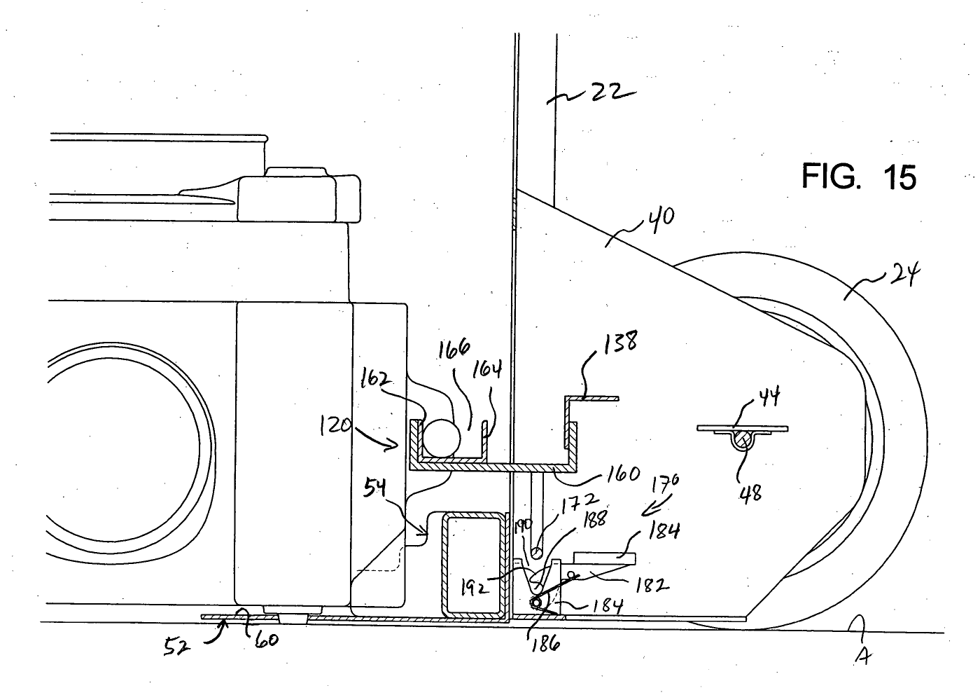

As perhaps best shown in FIGS. 13-16, the example latch assembly 170 comprises a latch housing 180, a latch member 182, a latch plate 184, and a latch spring 186. The latch member 182 defines a latch notch 188 (FIG. 15). The latch member 182 is pivotably supported by the latch housing 180 for rotation between closed (FIG. 13) and open (FIG. 14) positions. The latch spring 186 biases the latch member 182 into the closed position. Applying a force to the latch plate 184 greater than that applied by the latch spring 186 causes the latch member 182 to move from the closed position into the unclosed position.

Depressing the press plate 174 so that the bridge member 138 compresses the springs 134 and 136 allows the latch bar 172 to enter a housing notch 190 defined by the latch housing 180. The housing notch 190 directs the latch bar 172 into engagement with a curved upper surface 192 of the latch member 182. The latch bar 172 acts on the upper surface 192 to displace the latch member 182 from the closed position towards the unclosed position, allowing the latch bar 172 to enter the latch notch 188. At this point, the latch spring 186 forces the latch member 182 back into the closed position, capturing the latch bar 172 (FIG. 13). With the latch bar 172 so captured, the bridge member 138 supports the hook projection 120 in the second position.

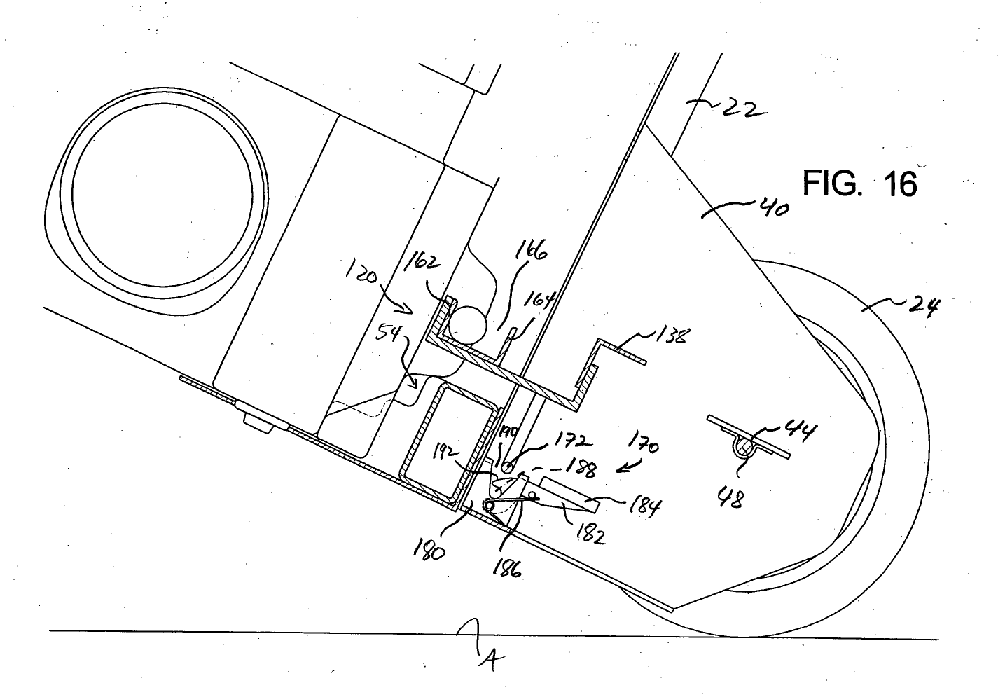

Applying a force to the latch plate 184 as shown by arrow B in FIG. 14 rotates the latch member 182 against the force of the latch spring 186 such that the latch member 182 no longer captures the latch bar 172. At this point, the springs 134 and 136 urge the bridge member 138 and thus the hook projection 120 towards the first position. When the force on the latch plate 184 is removed as shown in FIGS. 15 and 16, the latch spring 186 returns the latch member 182 to the closed position.

Referring now to FIG. 1 of the drawing, the example mounting panel 28 will be described in further detail. The mounting panel 28 is adapted to be secured to the frame 22 and defines one or more mounting openings 220. The example mounting panel 28 defines first, second, and third mounting openings 220a, 220b, and 220c. However, the mounting panel 28 may be comprised of one or more panel members each defining one or more mounting openings 220.

In addition, the mounting panel 28 (or the plurality of panel members) may be formed by methods such as stamping from a single sheet of material, injection molding, rotomolding, milling, or the like. The mounting openings 220 are configured to engage and support a piece of equipment and/or not to interfere with a piece of equipment carried by the support plate 52 and/or engaging system 26.

Additionally, the mounting panel 28 (or a plurality of single opening individual mounting panels) may be used outside of the context of the hand cart 20 as will be explained in further detail below.

With the foregoing detailed understanding of the construction and operation of the hand cart 20 in mind, examples of the use of this hand cart as part of a storage/transportation system of the present invention will now be described in detail.

I. Conventional Dolly

While not explicitly shown in the drawing, the hand cart 20 can be used in the manner of a conventional equipment dolly to transport equipment. In particular, the equipment may be placed on the support surface 60, and the frame tilted back until the weight of the equipment and hand cart 20 is carried by the wheels 24. The hand cart 20 may then be pushed or pulled along the structural surface A in a conventional manner. In this case, the form factor of the equipment carried by the hand cart 20 need not be known in advance.

II. Hanging Equipment

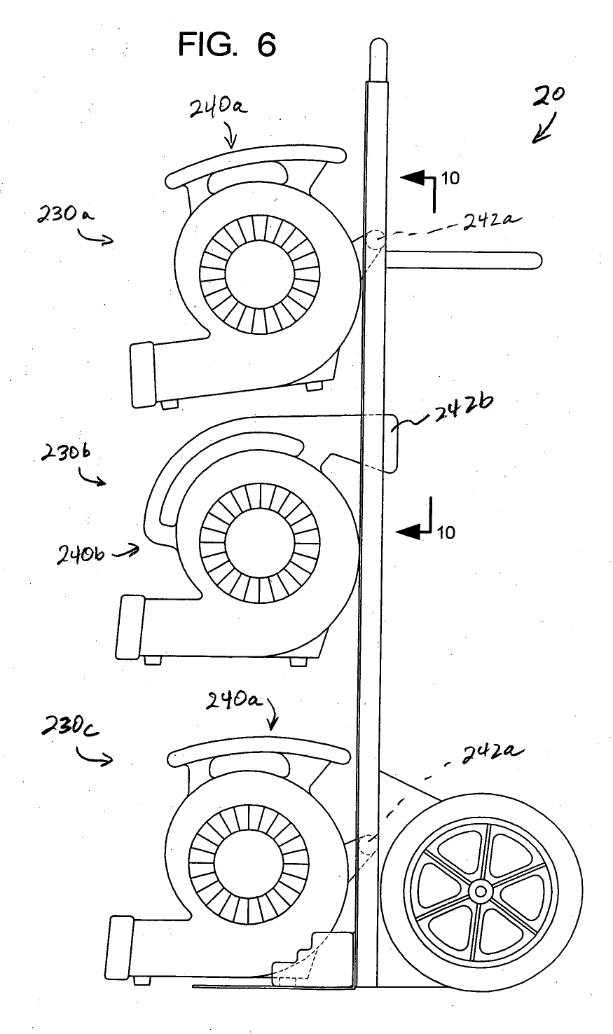

Referring initially to FIG. 6 of the drawing, the example hand cart 20 is shown being used to store first, second, and third air movers 230a, 230b, and 230c. The air movers 230a, 230b, and 230c are all hanging from the hand cart 20 rather than supported on the support surface 60.

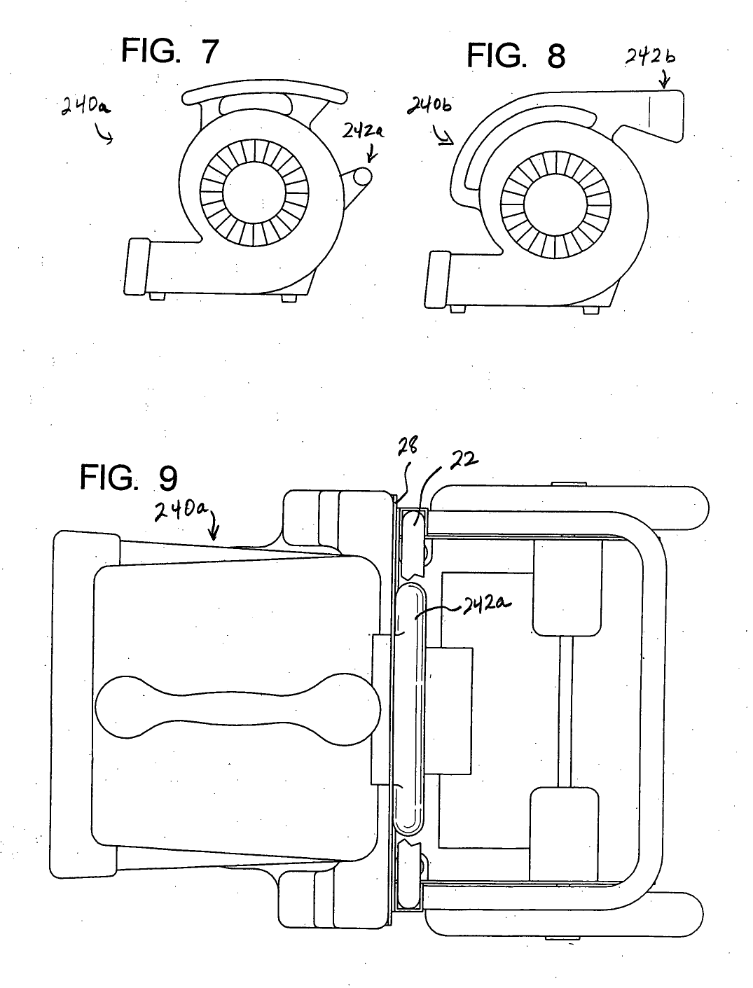

As perhaps best shown in FIGS. 7 and 8, the first and third air movers 230a and 230c confirm to a first form factor 240a, while the second air mover 230b conforms to a second form factor 240b. In particular, while roughly the same occupied volume, the first and second form factors differ in the placement of projections that function as handles or the like.

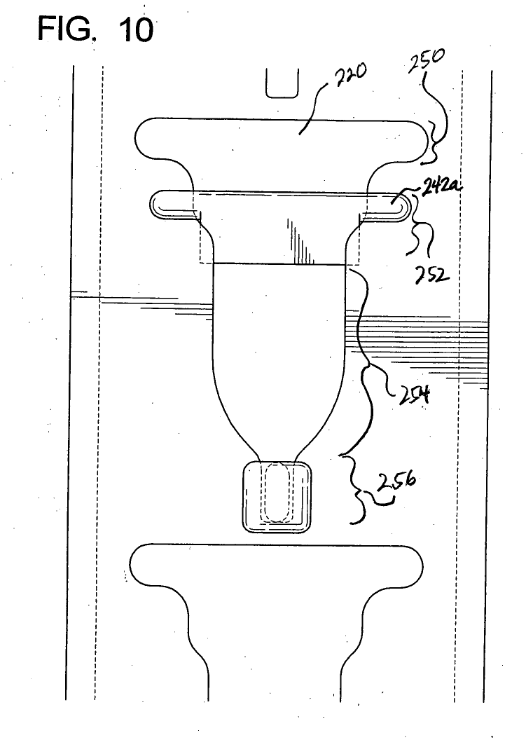

FIG. 10 illustrates that the example mounting openings 220a and 220b comprise a first portion 250, a second portion 252, a third portion 254, and a fourth portion 256. The example mounting opening 220c is the same but does not define the fourth portion 256. The exact configuration of the mounting openings 220 is not critical to the principles of the present invention in its broadest form, however. The configuration of the mounting openings will be determined based on the specifics of the form factor of equipment to be stored and/or transported thereby.

FIGS. 6, 8, 9, and 10 illustrate that the first form factor 240a comprises a structural projection. 242a and that the mounting openings 220 are all configured to allow the structural projection 242a to extend partly through the first portion 250 of the mounting openings 220 in the mounting panel 28. The weight of the air mover 230 causes the structural projection 242a to engage the portion of the mounting panel 28 around the second portion 252 of the mounting opening 220 to prevent inadvertent withdrawal of the projection 242a from the opening 220. The mounting panel 28 thus supports the air movers 230a in a desired position relative to the frame 22 of the hand cart 20. To remove the air mover 230a, the air mover 230a is lifted slightly to allow the structural projection 242a to pass through the first portion 250.

FIGS. 6 and 10 illustrate that a structural projection 242b defined by the second form factor 240b may be passed through any of the first, second, or third portions 250, 252, or 254. However, the weight of the air mover 230b causes the structural projection 242b to engage the portion of the mounting panel 28 around the fourth portion 256 of the mounting opening 220 to prevent inadvertent withdrawal of the projection 242b from the opening 220. The mounting panel 28 thus also supports the air mover 230b in a desired position relative to the frame 22 of the hand cart 20. To remove the air mover 230b, the air mover 230a is lifted slightly to allow the structural projection 242a to pass through any of the first, second, or third portions 250, 252, or 254.

While of significant utility when the form factor of the equipment hung from the mounting panel 28 is known in advance, the hand cart 20 may be used to transport equipment the form factor of which is not known in advance in a similar manner.

III. Hooked Equipment

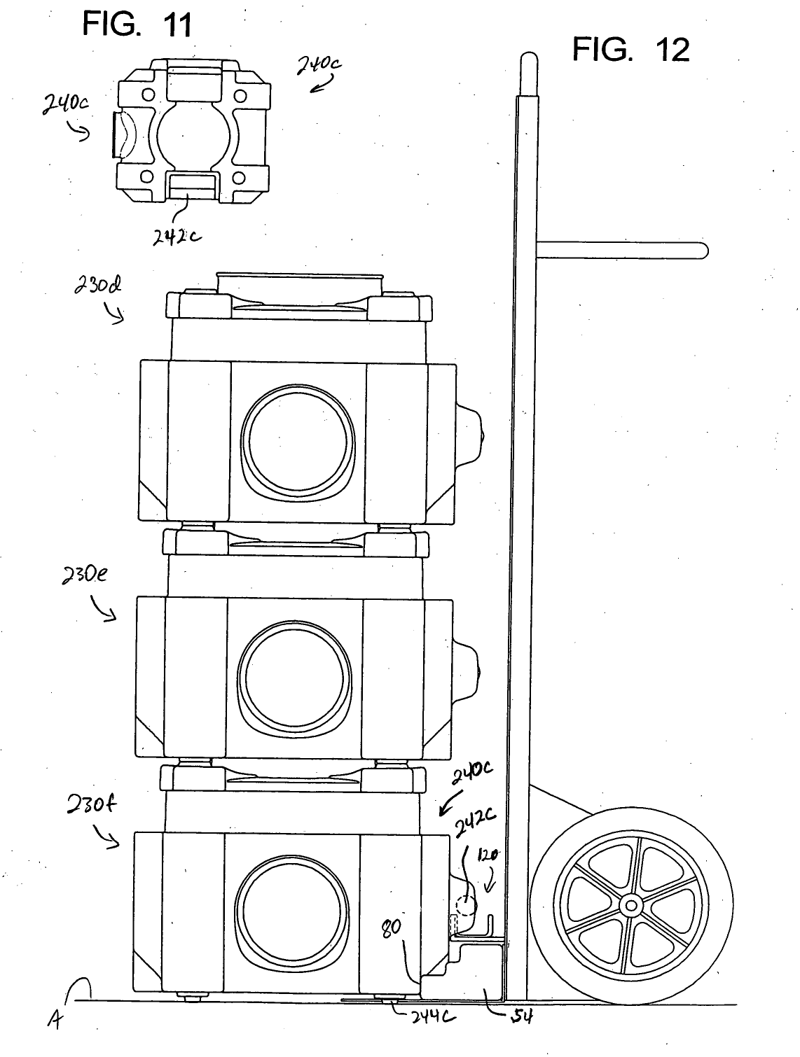

The use of the engaging system 26 when storing or transporting equipment using the hand cart 20 will now be described with reference to FIGS. 11-23. FIG. 11 illustrates a third form factor 240c of an air mover and that this form factor 240c comprises a handle portion 242c and foot portions 244c. FIG. 12 illustrates that the form factor 240c allows a plurality of air movers 230d, 230e, and 230f to be stacked one on top of the other and carried using the hand cart 20.

FIG. 11 further illustrates that the support plate 52 of the hand cart 20 extends between two of the foot portions 244c such that the surface 80 of the bumper member 54 engages the lowermost air mover 230f. In this position with the latch bar 172 engaged by the latch member 182, the hook channel 166 defined by the hook projection 120 is immediately below the handle portion 242c as shown in FIG. 13. Moving the latch member 182 to release the latch bar 172 as shown in FIG. 14 allows the springs 134 and 136 to force the hook projection 120 to move up and engage the handle portion 242c. The springs 134 and 136 are not fully extended and thus hold the hook portion 120 against the handle portion 242c.

As shown in FIG. 16, as the frame 22 of the hand cart 20 is tilted back such that the support plate 52 is lifted off of the ground, the weight of the hand cart 20 and air movers 230d, 230e, and 230f is carried by the wheels 24. In particular, the hand cart 20 is supported by the axle 48. The weight of the air movers 230d, 230e, and 230f is transferred to the frame 22 through hook projection 120, the bridge member 138, and the springs 134 and 136. In addition, the bumper surface 80 facilitates tilting of the stack of air movers 230d, 230e, and 230f by, in effect, pushing out on the lower corner of this stack as the frame 22 is tilted back.

At this point, the stack of air movers 230d, 230e, and- 230f may be transported in a generally conventional manner along the structural surface A.

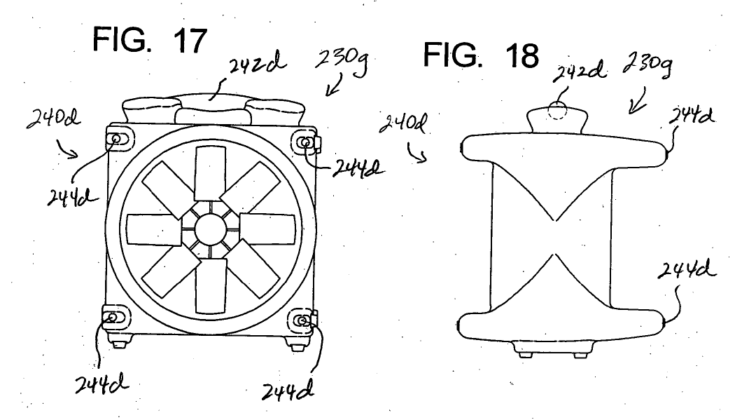

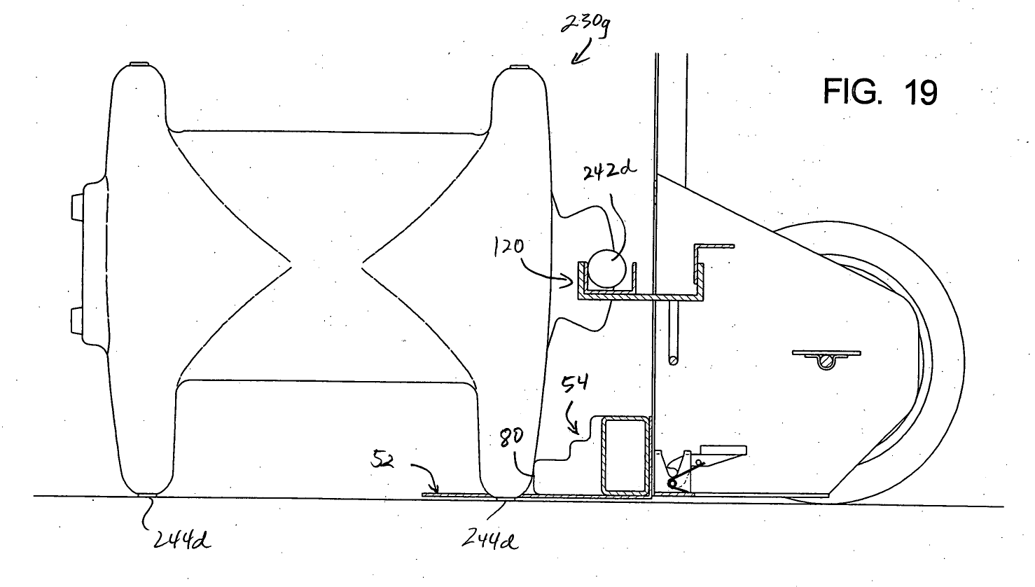

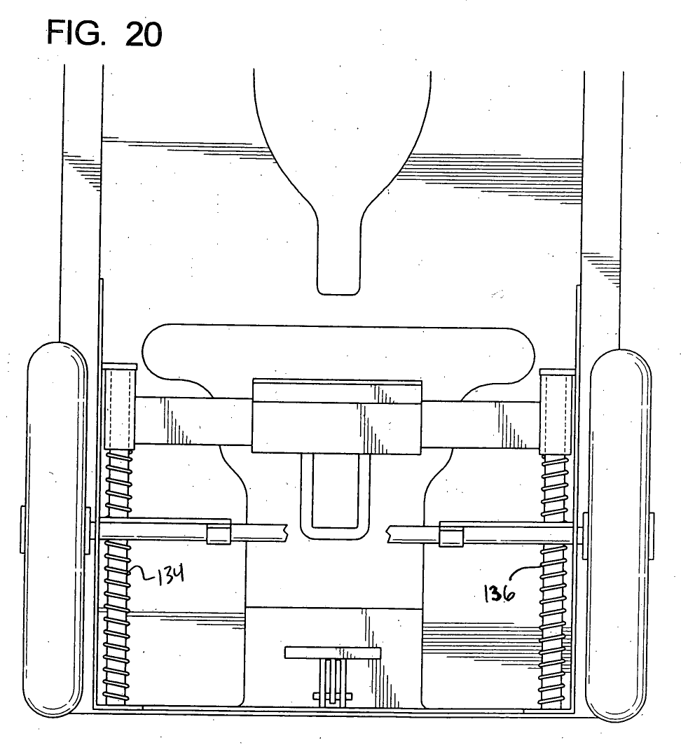

FIGS. 17 and 18 illustrate a fourth form factor 240d of an air mover and that this form factor 240d comprises a handle portion 242d and foot portions 244d. FIGS. 19-22 depict an air mover 230g of the fourth form factor 240d being moved using the example hand cart 20.

FIGS. 19 and 20 show the state of the engaging system 26 after the hand cart 20 is moved into a preload position adjacent to the air mover 230g but prior to tilting of the hand cart 20. At this point, the latch assembly 170 has released the latch bar 172 to allow the hook projection 120 to engage the handle portion 242d of the air mover 230g as shown in FIG. 19. FIG. 20 illustrates that the springs 134 and 136 are almost fully extended or are fully extended at this point.

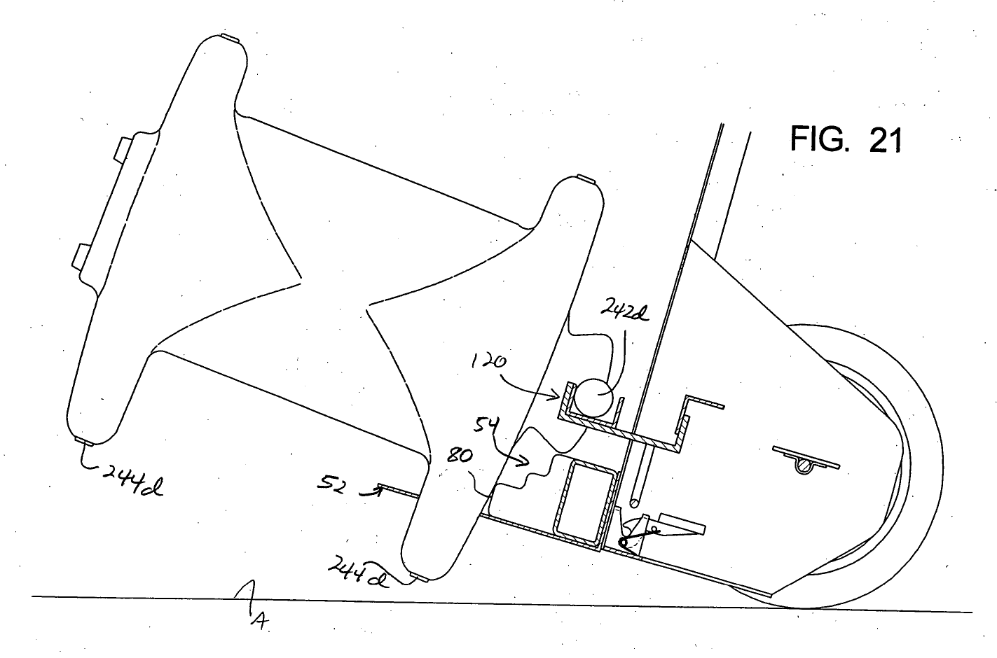

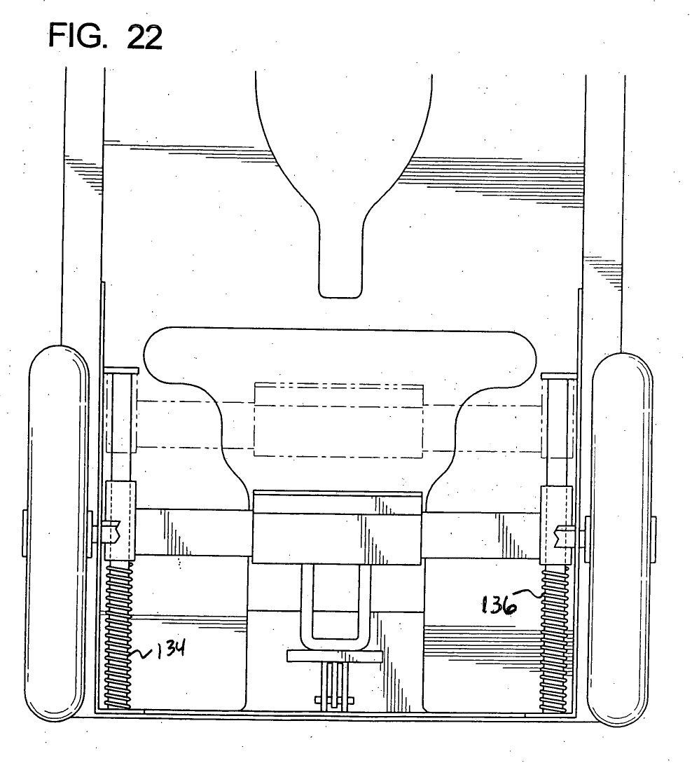

FIGS. 21 and 22 show the state of the engaging system 26 after tilting of the hand cart 20. The hook projection 120 engages the handle portion 242 of the air mover 230g to transfer the weight of the air mover 230g to the frame 22 through the bridge member 138 and the springs 134 and 136. The weight of the air mover 230g compresses the springs 134 and 136 as can be seen by a comparison of FIGS. 20 and 22. Although not specifically shown in FIGS. 12-16, a similar effect may occur when carrying the stack of air movers 230d, 230e, and 230f shown in FIG. 12, depending upon the strength of the springs 134 and 136.

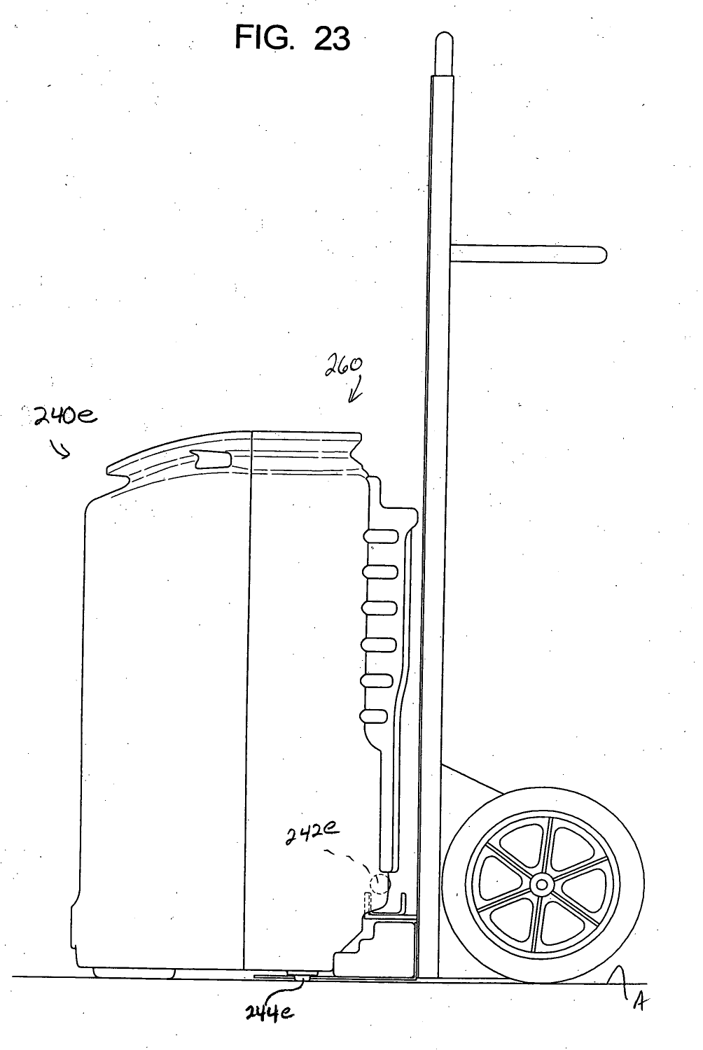

FIG. 23 depicts an example dehumidifier 260 to be carried by the example hand cart 20. The dehumidifier 260 defines a fifth form factor 240e that comprises a handle portion 242e and foot portion 244e. The dehumidifier 260 is generally conventional except that currently available dehumidifiers are typically provided with wheels, while the example dehumidifier 260 does not have wheels. Instead, the dehumidifier 260 relies on the wheels of the hand cart 20. The hand cart 20 can be used to store and/or transport the dehumidifier 260 in substantially the same as the stack of dehumidifiers 230d, 230e, and 230f or the single dehumidifier 230g as described above.

IV. Storage System

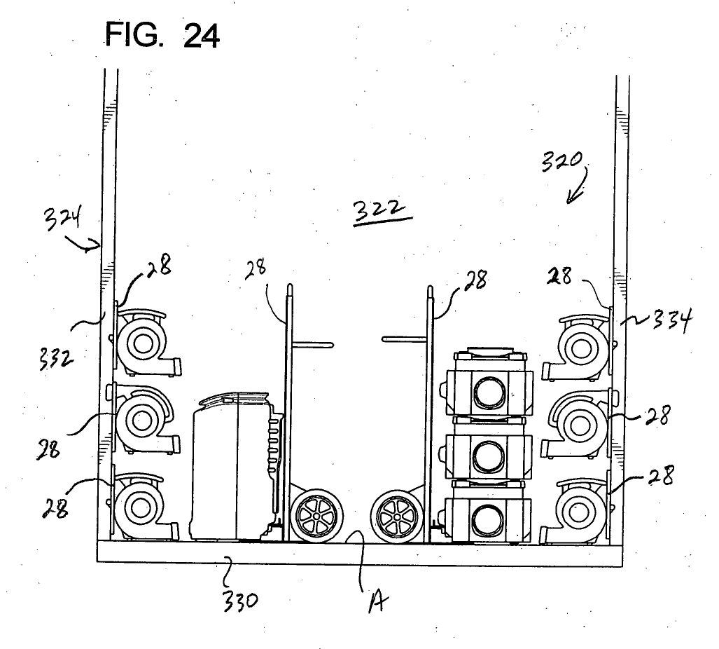

FIG. 24 depicts a plurality of hand carts 20 being used as part of a larger storage system 320. The storage system 20 is designed to be used in the context of a confined space 322 such as that defined by a vehicle 324. The example vehicle 324 may be a conventional van or truck comprising a floor 330 and walls 332 and 334. In this case, the floor 330 defines the structural surface A.

More specifically, the example storage system 320 comprises first and second hand carts 20a and 20b and a plurality of mounting panels 28. Mounting panels 28 are mounted on the hand carts 20a and 20b as described above and also on the walls 332 and 334 of the vehicle 324.

The storage system allows restorative drying equipment of the first, second, third, and fifth form factors to be stored within the vehicle 324 and/or transported by the vehicle 324. The storage configuration depicted in FIG. 24 is depicted by way of an example only, and other configurations may be used depending upon the number and types of equipment to be stored and the size and shape of the confined space 322.

V. Alternate Hand Cart

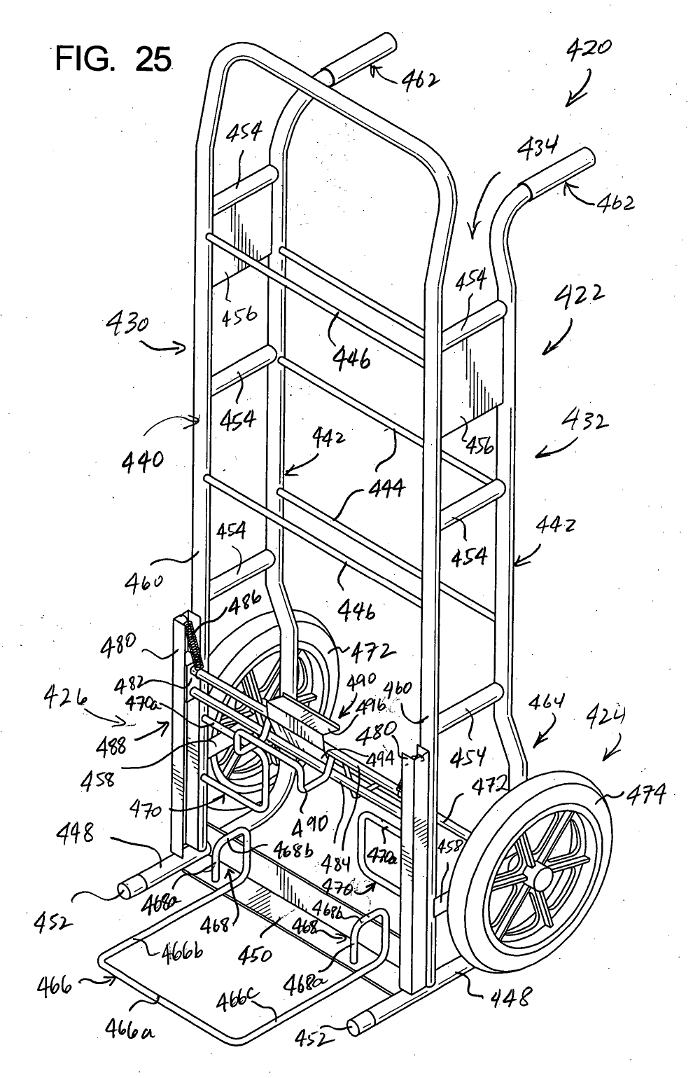

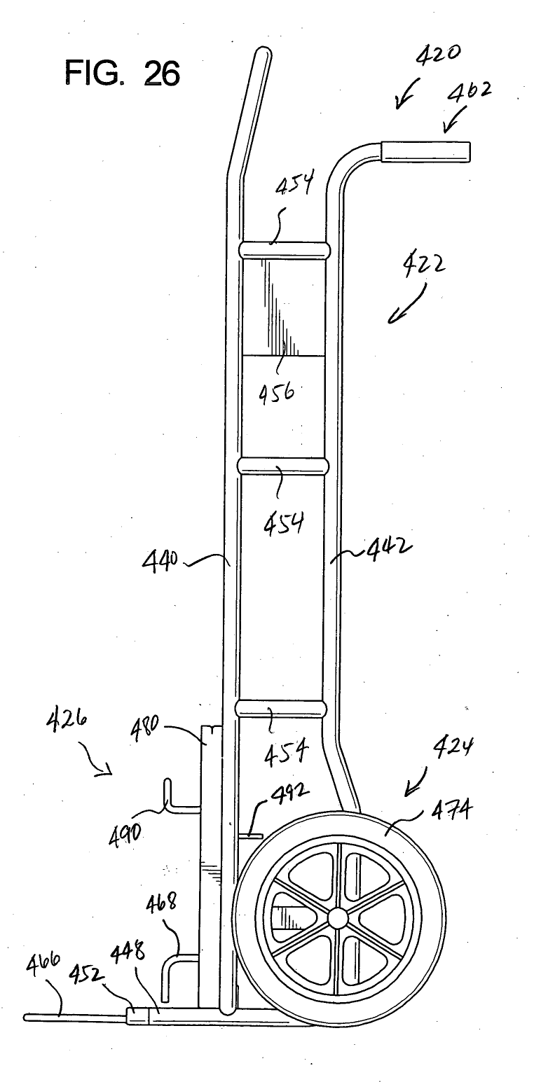

Referring now to FIGS. 25-32, depicted therein is a second embodiment of a hand cart 420 of the present invention. The hand cart 420 comprises a frame assembly 422, a wheel assembly 424, and an engaging system 426.

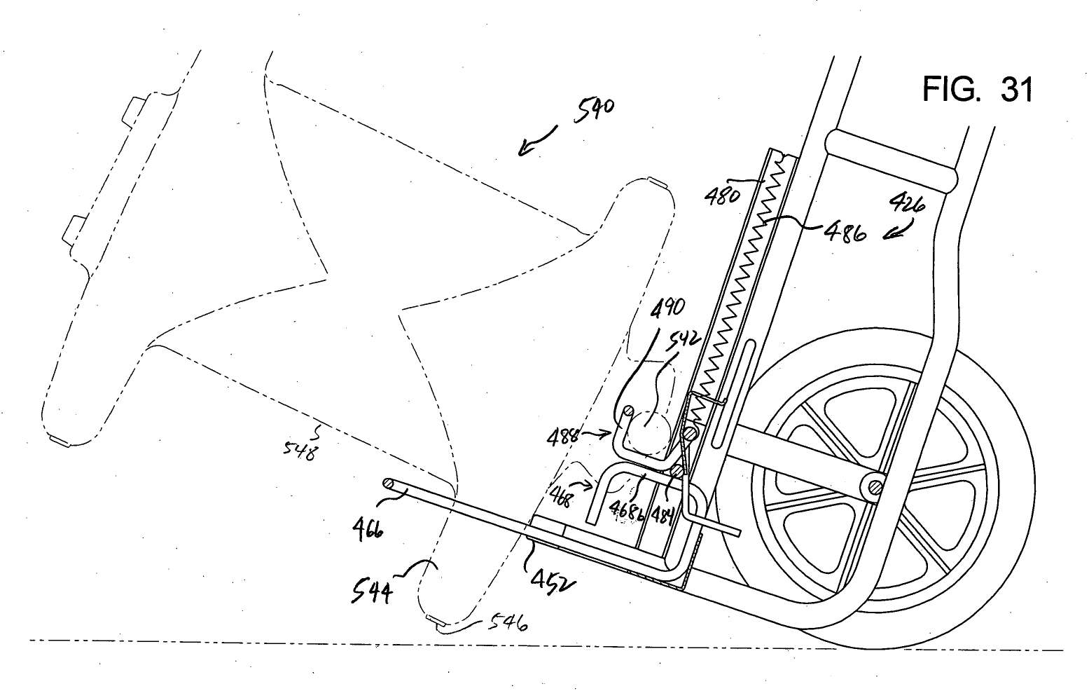

In the example hand cart 420, the frame assembly 422 defines a frame axis A; the frame axis A is substantially vertical when the hand cart 420 is standing upright as shown in FIG. 25 and is angled with respect to vertical when used to transport one or more items as shown in FIG. 31. The wheel assembly 424 and engaging system 426 are rigidly secured to the frame assembly 422. The wheel assembly 424 defines a wheel axis B that is substantially perpendicular to the frame axis A, and the engaging system 426 defines an engaging axis C that is substantially parallel to the frame axis A.

The example frame assembly 422 defines a front portion 430, a rear portion 432, and a spacing portion 434. The example spacing portion 434 is rigidly connected between the front portion 430 and the rear portion 432 to space the front and rear portions 430 and 432 from each other. The frame axis A extends along the rear portion 432. The example wheel assembly 424 is attached to the rear portion 432, and the engaging system 426 is attached to the front portion 430. The engaging axis C thus extends along the front portion 430, and the wheel axis B lies substantially along the frame axis A and is spaced relative to the engaging axis C.

The example frame assembly 422 comprises a front member 440 rigidly connected to a pair of rear members 442. The example frame assembly 422 further comprises a plurality of rear lateral members 444 that are rigidly connected between the pair of rear members 442. The front member 440 is in the form of an inverted U-shape, and a plurality of front lateral members 446 are rigidly connected between the downwardly extending arms of the front member 440.

The example rear members 442 each comprise an extension portion 448 that extends from the front portion 430 towards the rear portion 432. The bottoms ends of the downwardly extending arms of the front member 440 are rigidly connected to the extension portions 448. A bottom plate 450 is rigidly connected to the bottoms of the arms of the front member 440 and to the extension portions 448. Bumper portions 452 are formed on the forward most ends of the extension portions 448.

The front member 440 defines rail surfaces 460, while each of the rear members 442 defines a handle portion 462. The rear members 442 further define wheel portions 464 that are offset such that the wheel portions 464 are located below the handle portions 462. Rigidly connected to and extending from the bottom plate 450 is an extension rod 466. The example extension rod 466 comprises a distal end 466a that extends from and is substantially parallel to and coplanar with the bottom plate 450. The example extension rod 466 comprises arms 466b and 466c that space the extension rod 466 from the bottom plate 450.

The example extension rod 466 further defines a pair of stop members 468 that extend upwardly and forwardly from the bottom plate 450. The stop members 468 each define a forward portion 468a and a top portion 468b. The stop members 468 may be formed as part of the extension rod 466 as shown in the drawings or may be formed by separate members independently connected to the front members 440 and/or bottom plate 450.

In addition, in the example system 420 support rods 470 are connected to each of the front members 440 above the bottom plate 450 and below the lowermost front lateral member 446. The support rods 470 each define a support portion 470a.

A frame assembly used as part of the present invention should be capable of transmitting loads to the wheel assembly and supporting the engaging system to allow the hand cart to be used as will be generally described below. The exact construction of the example frame assembly 422 is not important to any particular implementation of the present invention.

The example wheel assembly 424 comprises an axle 472 to which are connected wheels 474. The axle 472 is connected to the wheel extension portions 464 of the rear members 442 by axle brackets 476. As is or may be conventional, the wheels 474 are free to rotate relative to the frame assembly 422. The exact construction of the wheel assembly 424 is not important to any particular implementation of the present invention, so long as the wheel assembly 424 is capable of bearing the loads placed thereon when the system 420 is used as will be described in further detail below.

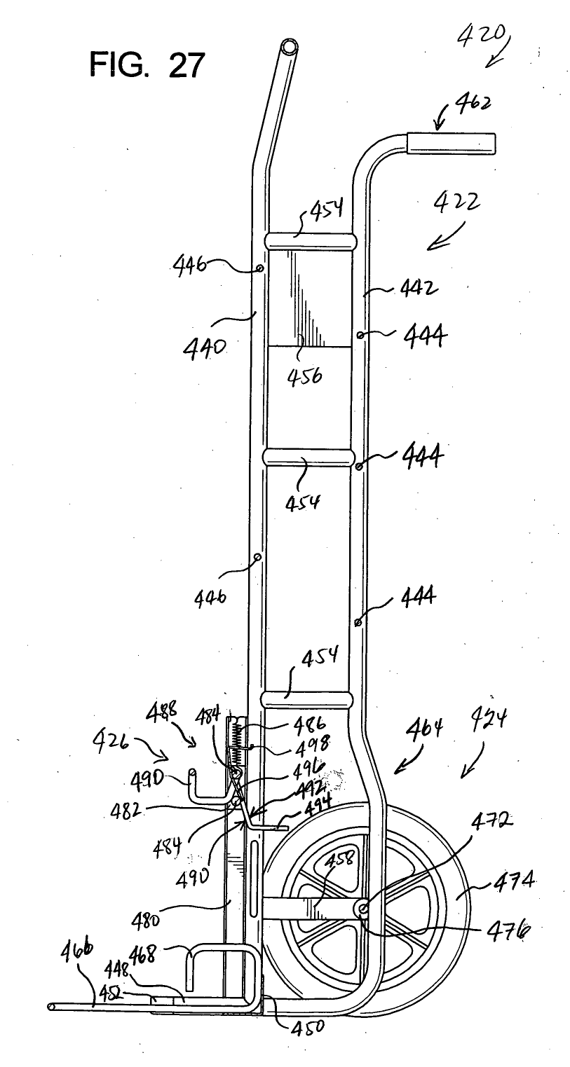

The example engaging system 426 comprises a pair of rail members 480, one connected to each of the rail surfaces 460 on the front members 440. The rail members 480 define opposing parallel channels that each receives a carriage member 482. The carriage members 482 are connected by carriage braces 484 to form a carriage assembly 488 that maintains the carriage members 482 within the channels. The carriage assembly 488 is capable of moving along the engaging axis C relative to the frame assembly 422 between an upper position (e.g., FIG. 27) and a lower position (e.g., FIG. 31). Carriage springs 486 are connected to each of the carriage members 482 to bias the carriage assembly 488 upwards along the engaging axis C. A hook member 490 extends from the carriage assembly 488 to a front side of the front portion 430. In particular, the hook member 490 is rigidly connected to one or both of the carriage braces 484.

The exact construction of the carriage assembly 488 and hook member 490 is not important to any particular implementation of the present invention. The carriage assembly 488 may be any structure capable of moving relative to the frame assembly 422 while bearing the loads on the hook member 490 as will be described below. The hook member 490 may be any structure that engages the types of equipment that the hand cart 420 has been designed to accommodate.

A step plate 492 is also connected to the carriage braces 484. The step plate 492 comprises a foot portion 494, an attachment portion 496, and a cover portion 498. The foot portion 494 extends rearwardly between the front and rear portions 430 and 432. The cover portion 498 extends rearwardly above the foot portion 494. The attachment portion 496 extends between the foot portion 494 and the cover portion 498 between the carriage braces 484 and is rigidly connected to the braces 484. The exact construction of the step plate 492 is not important so long as it facilitates displacement of the carriage assembly 488 downward as will be described in further detail below.

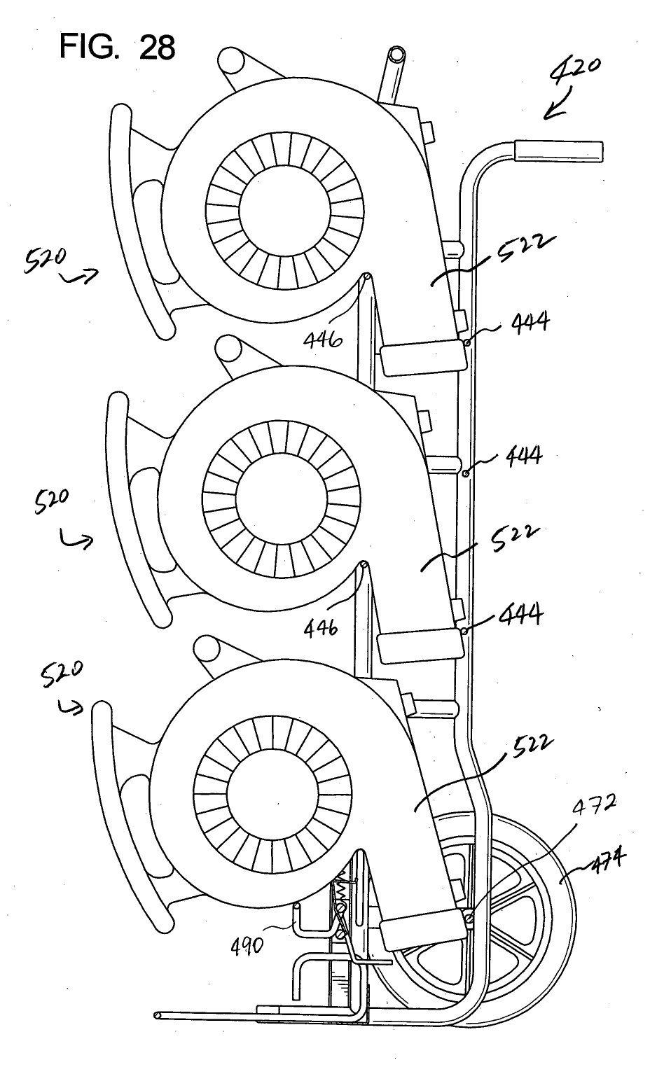

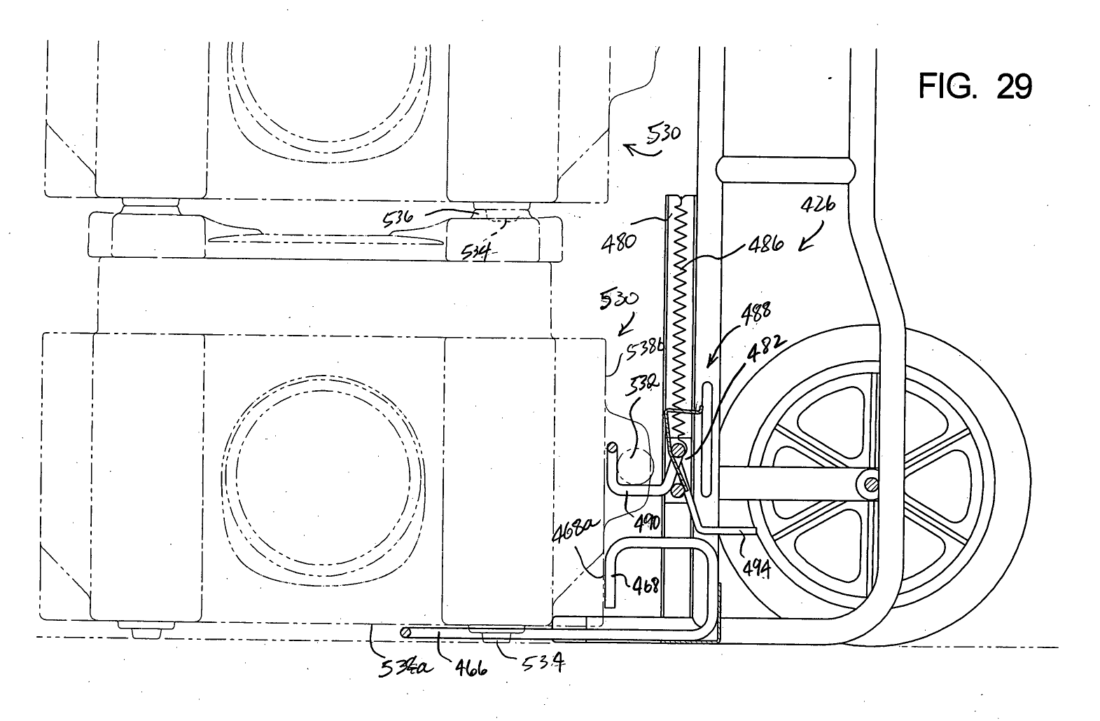

Referring now to FIGS. 28-32, several examples of methods of using the example hand cart 420 will now be described. In FIG. 28, the hand cart 420 is shown supporting three blower assemblies 520 having a particular form factor. In particular, the upper two blower assemblies 520 have snout portions 522 that are passed above the front lateral members 446 and below rear lateral members 444 associated therewith. These lateral members 446 and 444 thus support the upper two blower assemblies 520 relative to the frame assembly 422. The lower most blower assembly 520 is passed above the support surfaces 470a of the support rods 470 and below the axle 472. The support surfaces 470a and the axle 472 support the lower most blower assembly 520 relative to the frame assembly 422.

All three blower assemblies 520 are thus supported relative to the frame assembly 422 and may be transported in a conventional manner by tipping the hand cart 420 back so that the weight of the blower assemblies 520 is transferred to the wheel assemblies 424 and rolling the hand cart 420 and blower assemblies 520 along a support surface.

Referring now to FIG. 29, the hand cart 420 is shown transporting a plurality of blowers 530. These blowers 530 each comprise a lift bar 532, a plurality of foot projections 534, and a plurality of foot sockets 536. The foot sockets 536 are designed to receive the foot projections 534 so that several of the blowers 530 can be stably stacked on top of each other.

To carry a plurality of blowers 530 as shown in FIG. 29, one or more of the blowers 530 are stacked on a bottom most of the blowers 530. Initially, the user displaces the carriage assembly 488 down against the force of the carriage springs 486 by pressing on the step plate 492, typically by stepping on the foot portion 494 of the plate 492. The user then positions the hand cart 420 such that the forward portion 466a of the extension rod 466 is below the bottom most blower 530, with the arm portions 466b and 466c between two of the foot projections 534 of the blower 530. The user then allows carriage springs 486 to raise the carriage assembly 488 such that the hook member 490 engages the lift bar 532 of the lower most blower 530 as shown in FIG. 29.

At this point, the hand cart 420 can be tipped back in a conventional manner. The engagement of the hook member 490 with the lift bar 532 pulls the stack of blowers 530 backwards, while the extension rod 466 pushes up on a bottom surface 538a and the forward portions 468a of the stop member 468 engage a rear surface 538b of the lower most blower 530. The stack of blowers 530 thus also tips backwards with the hand cart 420 and can thus be transported by rolling the hand cart 420 on its wheels 474.

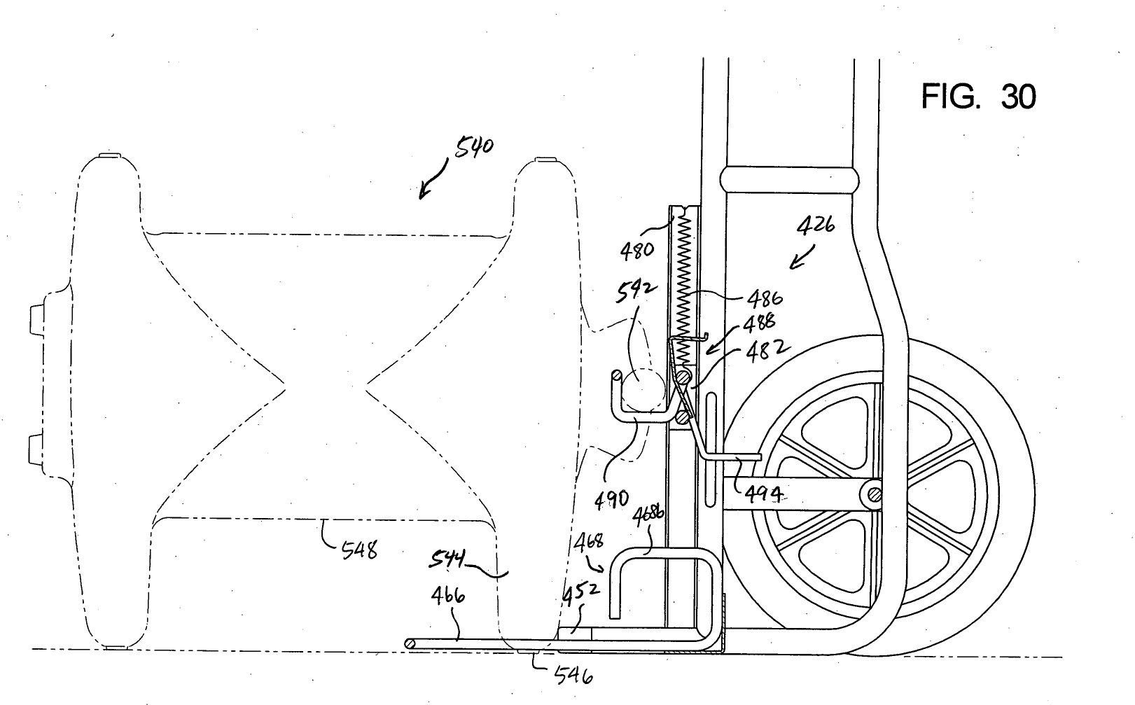

Referring now to FIGS. 30 and 31, the hand cart 420 is depicted transporting another type of blower 540. The blower 540 comprises a lift bar 542 and a plurality of leg portions 544. The leg portions 544 define blower feet 546 that are spaced from a lower surface 548 of the blower 540.

To use the hand cart 420 to move the blower 540, the user first displaces the carriage assembly 488 down against the force of the carriage springs 486 by pressing on the step plate 492, typically by stepping on the foot portion 494 of the plate 492. The user then positions the hand cart 420 such that the forward portion 466a of the extension rod 466 is below the lower surface 548a of the blower 540 and the arm portions 466b and 466c are between two of the leg portions 544 of the blower 540. At this point, the bumper portions 452 of the rear members 442 also engage a rear surface 548b of the blower 540. The user then allows carriage springs 486 to raise the carriage assembly 488 such that the hook member 490 engages the lift bar 542 of the blower 540 as shown in FIG. 30.

At this point, the hand cart 420 can be tipped back about a pivot point defined by the wheels 474. However, the lower surface 548 is significantly above the extension rod 466. Further, the carriage springs 486 are not strong enough to support the weight of the blower 540, so these springs 486 extend as the hand cart 420 is pivoted. Accordingly, tipping the hand cart 420 initially merely pivots the blower 540 backwards on the foot portion 546.

At some point, the carriage assembly 488 engages the upper portions 468b of the stop members 468. At that point, the springs 486 no longer extend, and the hook member 490 engages the lift bar 542 and the bumper portions 452 engage the leg portions 544 to lift the blower 540 off the ground as shown in FIG. 31. Once the blower 540 is off the ground, the hand cart 420 can be used to transport the blower 540. While only one blower 540 is shown in FIGS. 30 and 31, more than one blower can be transported in this way by stacking other blowers on top of the blower shown in these figures. In addition, a blower such as the blower 520 described above may be supported above the single blower 540.

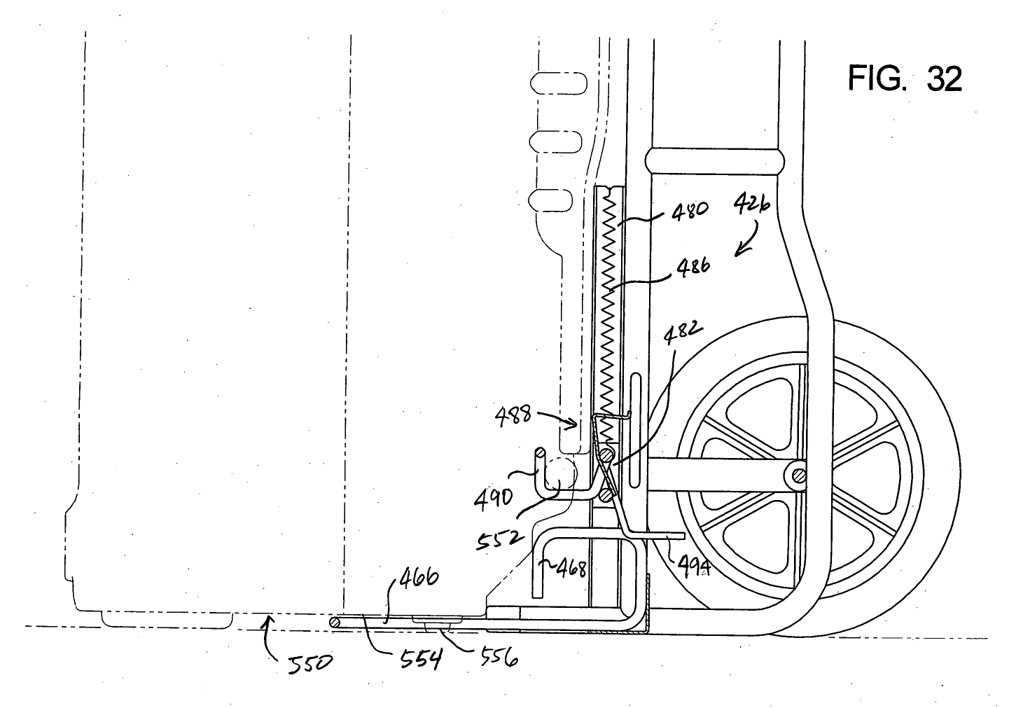

Referring now to FIG. 32 of the drawing, the hand cart 420 is shown lifting a dehumidifier 550. The dehumidifier 550 comprises a lift bar 552 and defines a bottom surface 554 from which feet projections 546 extend.

To transport a dehumidifier 550 as shown in FIG. 32, the user initially displaces the carriage assembly 488 down against the force of the carriage springs 486 by pressing on the step plate 492, typically by stepping on the foot portion 494 of the plate 492. The user then positions the hand cart 420 such that the forward portion 466a of the extension rod 466 is below the dehumidifier 550, with the arm portions 466b and 466c between two of the foot projections 556 of the dehumidifier 550. The user then allows carriage springs 486 to raise the carriage assembly 488 such that the hook member 490 engages lift bar 552 of the dehumidifier 550 as shown in FIG. 29.

At this point, the hand cart 420 can be tipped back in a conventional manner. The engagement of the hook member 490 with the lift bar 552 pulls the dehumidifier 550 backwards, while the extension rod 466 pushes up on the bottom surface 554. The dehumidifier 550 thus also tips backwards with the hand cart 420 and can thus be transported by rolling the hand cart 420 on its wheels 474.

The example hand cart 420 may, in addition, be used as part of a larger system as described above.

What is claimed is:

1. A hand cart for a first item having a lift bar, comprising:
a frame assembly;
a wheel assembly rigidly connected to the frame assembly to facilitate movement of the hand cart along a surface;
a carriage assembly connected to the frame assembly for movement along an engaging axis relative to the frame assembly; and
a hook extending from the carriage assembly; whereby with the frame assembly adjacent to the first item, the carriage assembly is displaced such that the hook engages the lift bar of the first item; and
with the hook engaging the lift bar, the frame assembly is tilted such that the wheel assembly supports the first item for transport.

2. A hand cart as recited in claim 1, in which the carriage assembly moves between upper and lower positions relative to the frame, the hand cart further comprising a spring member for biasing the carriage assembly towards the upper position.

3. A hand cart as recited in claim 2, further comprising a latch assembly for latching the carriage assembly in a lower position.

4. A hand cart as recited in claim 1, in which the frame assembly is adapted to engage and support a second item for transport.

5. A hand cart as recited in claim 1, in which the frame assembly comprises at least one portion adapted to engage a back surface of the first item.

6. A hand cart as recited in claim 1, in which the frame assembly comprises at least one portion adapted to engage a bottom surface of the first item.

7. A hand cart as recited in claim 1, in which the frame assembly comprises:
a first portion adapted to engage a back surface of the first item; and
a second portion adapted to engage a bottom surface of the first item.

8. A hand cart as recited in claim 1, in which the frame assembly comprises a front portion, a rear portion, and a spacing portion arranged to space the front and rear portions from each other, wherein:
the carriage assembly is movably connected to the front portion; and
the wheel assembly is connected to the rear portion.

9. A hand cart as recited in claim 4, in which the frame assembly comprises front and rear lateral members, where the front and rear lateral members are spaced from each other to engage and support the second item.

10. A hand cart as recited in claim 4, in which support panels are secured to the frame assembly, where the support panels are configured to engage and support the second item.

11. A hand cart as recited in claim 1, in which the carriage assembly moves between upper and lower positions relative to the frame, the frame further comprising a stop member arranged to engage the carriage assembly when the carriage assembly is in the lower position.

12. A hand cart as recited in claim 1, in which the frame assembly comprises an extension portion that extends under the item when the item is transported.

13. A hand cart as recited in claim 1, further comprising first and second rails attached to the frame assembly, in which the carriage assembly comprises:
first and second carriage members adapted to move along the rails; and
at least one carriage brace extending between the first and second carriage members; where
the hook is rigidly connected to the at least one carriage brace.

14. A hand cart as recited in claim 1, in which the carriage assembly further comprises a foot plate defining a foot portion to facilitate movement of the carriage assembly relative to the frame assembly.

15. A method of moving at least a first item having a lift bar, comprising the steps of:
providing a frame assembly;
rigidly connecting a wheel assembly to the frame assembly;
connecting a carriage assembly to the frame assembly such that the frame assembly may move along an engaging axis relative to the frame assembly;
rigidly connecting a hook to the carriage assembly;
arranging the frame assembly adjacent to the first item;
displacing the carriage assembly is displaced such that the hook engages the lift bar of the first item;
with the hook engaging the lift bar, tilting the frame assembly such that the wheel assembly supports the first item for transport; and
moving the frame assembly to displace the first item.

16. A method as recited in claim 15, in which the step of connecting the wheel assembly to the frame assembly comprises the step of connecting the carriage assembly to the frame assembly such that the carriage assembly may be moved between upper and lower positions relative to the frame, the method further comprising the step of biasing the carriage assembly towards the upper position.

17. A method as recited in claim 15, further comprising the step of arranging a second item to engage the frame assembly such that the frame assembly supports a second item for transport.

18. A hand cart for a first item having a lift bar, comprising:
a frame assembly;
a wheel assembly rigidly connected to the frame assembly to facilitate movement of the hand cart along a surface;
a carriage assembly connected to the frame assembly for movement between upper and lower positions along an engaging axis relative to the frame assembly;
a biasing member for biasing the carriage assembly towards the upper position; and
a hook extending from the carriage assembly; whereby with the frame assembly adjacent to the first item, the carriage assembly is displaced such that the hook engages the lift bar of the first item; and
with the hook engaging the lift bar, the frame assembly is tilted such that the wheel assembly supports the first item for transport.

19. A hand cart as recited in claim 18, further comprising a latch assembly for latching the carriage assembly in a lower position.

20. A hand cart as recited in claim 18, further comprising first and second rails attached to the frame assembly, in which the carriage assembly comprises:
first and second carriage members adapted to move along the rails; and
at least one carriage brace extending between the first and second carriage members; where
the hook is rigidly connected to the at least one carriage brace.
